(19) United States
(12) Patent Application Publication
(10) Pub. No.: US 2025/0281974 A1
(43) Pub. Date: Sep. 11, 2025

(54) CONTROL DEVICE FOR A METALLURGICAL VESSEL STOPPER-ROD

(71) Applicant: VESUVIUS-SERT, SAS, Decines-Charpieu (FR)

(72) Inventors: Patrick ARNULF, Decines-Charpieu (FR); Raphael BESSON, Decines-Charpieu (FR); Didier BERLIER, Decines-Charpieu (FR)

(73) Assignee: VESUVIUS-SERT, SAS, Decines-Charpieu (FR)

(21) Appl. No.: 18/854,661

(22) PCT Filed: Apr. 7, 2023
(86) PCT No.: PCT/EP2023/059310

§ 371 Date: Oct. 7, 2024

(30) Foreign Application Priority Data
Apr. 8, 2022 (EP) 22167346.0

(51) Int. Cl. B22D 41/20; B22D 37/00

(52) U.S. Cl. CPC B22D 41/20; B22D 37/00

(57) ABSTRACT

Control device (10) for a metallurgical vessel stopper-rod, operable to switch between a manual mode and an automatic mode, the stopper-rod being manually actuated by an operator in the manual mode for a manual control of a molten metal flow, while in the automatic mode, the stopper-rod is actuated by the driving element (20) for an automatic control of the molten metal flow, the device (10) comprising: a rotating member (110) pilotable about an axis (X); a hand lever (120) pilotable about the axis (X); a coupling mechanism (130) connecting the rotating member (110) and the hand lever (120), the coupling mechanism (130) being structured so that in a disengaged state, the rotating member (110) and the hand lever (120) are both rotatable about the axis (X) independently, while in an engaged state, the hand lever (120) and the rotating member (110) rotate together about the axis (X) of rotation.

### FIELD OF THE INVENTION

The invention relates to a control device for a metallurgical vessel stopper-rod, said control device in combination with an electric, pneumatic or hydraulic driving element, a kit for mounting an metallurgical vessel stopper-rod assembly comprising said control device, a process for controlling a molten metal flow discharged from a metallurgical vessel comprising the use of said control device as well as the use of said control device.

### BACKGROUND AND PRIOR ART

Traditionally metallurgical vessels are drained using a stopper-rod controlling the molten material flowing through a pouring orifice. The vertical displacement of the stopper-rod is either automatically or manually controlled. A hand lever for the manual control is provided. However, the hand lever permanently cooperates with the stopper-rod, even during an automatic control. The drawback is that the hand lever oscillates during the automatic control, presenting a risk for an operator. There would even be a risk that the hand lever would get into resonance during oscillation operation and, in extreme cases break.

In order to overcome this limitation, DE4424546A1 discloses a control device for a stopper-rod comprising a hand lever with a lockable pivoting mechanism in a middle position of the hand lever between a proximal section and a distal section of the hand lever. On one hand, the proximal section engages with a vertical guide rod that cooperates with the stopper rod, wherein the proximal section and the vertical guide rod form a translation rotation mechanism, for transforming a rotation of the proximal section into a vertical displacement of the vertical guide rod. On the other, the distal section is holdable by an operator. The pivoting mechanism can be either locked allowing rigid connection between the two sections or free allowing a rotation between the two sections. The unlocking of the pivot mechanism reduces the inertial effects during the automatic control because the free end of the distal section can rest on the floor. However, the proximal section is still connected to the guide rod that vertically reciprocates during the automatic control, and this causes perturbations. Furthermore, the end of the proximal section that is connected the pivot mechanism remains loosely connected to the distal section causing further perturbations, particularly cyclic perturbations.

### AIMS OF THE INVENTION

The invention aims to provide a solution to at least one drawback of the teaching provided by the prior art.

More specifically, the invention aims to provide a solution to improve the control of the stopper-rod, in particular to ensure that the control device of the stopper-rod is free of perturbations during an automatic control.

### SUMMARY OF THE INVENTION

For the above purpose, the invention is directed to a control device for a metallurgical vessel stopper-rod, said device being operable to switch between a manual mode and an automatic mode, said device being connectable to an electric, pneumatic or hydraulic driving element, said stopper-rod being manually actuated by an operator in the manual mode for a manual control of a molten metal flow, while in the automatic mode, said stopper-rod is actuated by said driving element for an automatic control of the molten metal flow, said device further comprising: a rotating member, in particular in a cam-, gear-, arm- or crank-member form, movable in rotation about an axis of rotation, wherein the control device is structured so that the rotating member mechanically cooperates with said stopper-rod in such manner that a vertical displacement of said stopper-rod is a function of a rotation of the rotating member causing the rotating member to cooperate mechanically with the driving element in use; a hand lever movable in rotation about the axis of rotation and holdable by an operator to manually control the vertical displacement of said stopper-rod in the manual mode; a coupling mechanism connecting the rotating member and the hand lever, said coupling mechanism being structured so that in a disengaged state, the rotating member and the hand lever are both rotatable about the axis independently from one another thereby preventing the transfer of mechanical power from the driving element to the hand lever in the automatic mode, while in an engaged state, the hand lever and the rotating member rotate together about the axis of rotation thereby allowing said stopper-rod being manually actuated by an operator in the manual mode.

According to specific embodiments of the invention, the control device for a metallurgical vessel stopper-rod comprises one of more the following technical features, taken in isolation or any combination thereof:
the hand lever comprises a proximal section adjacent to the rotating member and a distal section including a handle section, said distal section being detachable from said proximal section;
the coupling mechanism comprises a sliding member, optionally in a plunger form, mounted in translation relative to the hand lever and a recess formed in the rotating member, said coupling mechanism being structured so that the sliding member is engaged with the recess when the coupling mechanism is in the engaged state;
the recess comprises a guiding portion with a funnel shape surface so as to guide the sliding member during a transition from the disengaged state to the engaged state;
the recess comprises a cylindrical or prismatic lock portion ensuring a locking between the sliding member and the rotating member in the engaged state;
the hand lever comprises an actuating member, preferably a hand actuating member, more preferably a lever, for selecting either the engaged or disengaged state;
the actuating member mechanically cooperates with the sliding member via a Bowden cable means;
the distal section of the hand lever comprises an end portion presenting a protrusion and the proximal section comprises an end face with a recess formed thereon, said protrusion being adapted to be engaged in a form-fit manner in said recess when the distal section is attached to the proximal section;
the sliding member is received within a chamber formed in the protrusion of the distal member;
the sliding member is biased by a resilient means in a deployed configuration, in which the sliding member is engaged with the recess in use, and connected to the actuating member, in particular the lever, via a cable of the Bowden cable means, said cable extending from a sliding member end portion to an arm of the actuating member, wherein optionally the actuating member is in lever form;
the control device is structured to be operable in a transient mode during a transition from the manual control to the automatic control or vice versa, in which the stopper-rod is actuated by said driving element for an automatic control of the molten metal flow while the coupling mechanism is in the engaged state, causing the hand lever to be actuated by the driving element and to rotate together with the rotating member;
when the coupling mechanism is in the engaged state, the coupling mechanism is structured so that: the maximal of offset angle between the rotating member and the hand lever amounts to 2°, preferably 1°, and/or the rotating member rotates rigidly with the hand lever;
the axis of rotation is static when the control device is in use.

The invention also relates to the control device for a metallurgical vessel stopper-rod in combination with an electric, pneumatic or hydraulic driving element.

The invention also relates to a kit for mounting a stopper-rod assembly, wherein said kit comprises a stopper-rod, the control device as described supra for a metallurgical stopper-rod and an electric, pneumatic or hydraulic driving element for being connected to said control device, said assembly being adapted to be arranged in or at a bottom of a metallurgical vessel, in particular a tundish or ladle. The invention also relates to a metallurgical vessel, such as a tundish or ladle, comprising said stopper-rod assembly.

The invention also relates to a process for controlling a molten metal flow discharged from a metallurgical vessel, in particular a tundish or ladle, comprising the use of the control device for a metallurgical vessel stopper-rod.

The invention also relates to the use of the control device for a metallurgical vessel stopper-rod.

The present invention is also advantageous since before switching to a manual control, the hand lever is totally static thanks to the coupling mechanism. Furthermore, when an operator wants to switch to the manual mode, she/he does not have to perform complex operations since the control of the locking mechanism is performed remotely via a handle section arranged at the free end of the hand lever. Moreover, a distal section of the hand lever can be easily detached form a proximal section and then stored in an appropriate location. The distal section can be easily attached to or detached from the proximal section that remains static even an automatic mode is in progress. Compared to the above-mentioned prior art, the axis X of rotation of the coupling mechanism is both static and coaxial with the axis of rotation of the translation rotation mechanism (transforming a rotation of the hand lever into a vertical displacement of the stopper-rod), thereby minimizing the inertial effects.

In general, the preferred embodiments of each subject-matter of the invention are also applicable to the other subject-matters of the invention. As far as possible, each subject-matter of the invention is combinable with other subject-matter. The features of the invention are also combinable with the embodiments of the description, which in addition are combinable with each other.

### BRIEF DESCRIPTION OF THE FIGURES

Preferred aspects of the invention will now be described in more detail with reference to the appended drawings, wherein same reference numerals illustrate same features and wherein:

FIG. 1 represents a side view of a control device according to the one embodiment of the invention in combination with a guiding unit and an electric driving element.

FIG. 2A represents a side view of a control device with a crank mechanism according to one embodiment of the invention.

FIG. 2B represents a side view of a control device with a gear rack mechanism according to one embodiment of the invention.

FIG. 2C represents a side view of a control device with a lever mechanism according to one embodiment of the invention.

FIG. 2D represents a side view of a control device with a cam follower mechanism according to one embodiment of the invention.

FIG. 3 shows a perspective view of a coupling mechanism according to one embodiment of the invention.

FIG. 4 represents a sectional view of a coupling mechanism according to one embodiment of the invention.

### LIST OF REFERENCE SYMBOLS

10 Control mechanism
20 Diving element
101 Connecting rod
102 Guiding body
103 Stopper-rod arm connection means
110 Rotating member
120 Hand lever
121 Proximal section
122 Actuating member, lever
123 Distal section
124 Cable
125A, 125B Proximal arms
126 Handle section
127 End face protrusion of the distal section
128 End face recess of the proximal section
129 Chamber
130 Coupling mechanism
132 Sliding member, plunger
134 Rotating member recess
134.1 Lock portion of the rotating member recess
134.2 Guiding portion of the rotating member recess
X Rotation axis

### DESCRIPTION OF PREFERRED EMBODIMENTS OF THE INVENTION

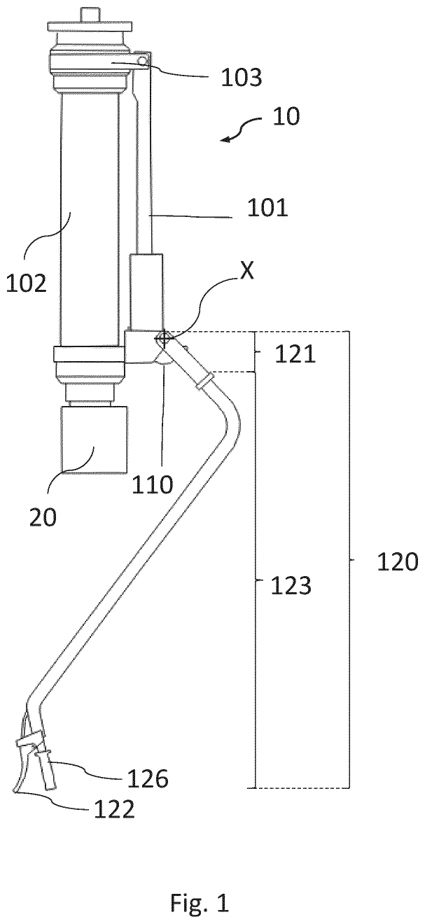

FIG. 1 is a side view of a control device 10 for a metallurgical vessel stopper-rod for use in controlling a molten metal flow discharged from a metallurgical vessel. The control device 10 is operable to switch between a manual control mode and an automatic control mode. For the purpose of the manual control mode, the control device comprises a hand lever 120, a rotating member 110 and also advantageously a connecting rod 101, which are discussed in more detail below. In a preferred embodiment, the control device 10 is actuated by an electric driving element 20 for the automatic control of a molten metal flow. The driving element 20 cooperates mechanically with a vertically sliding member provided inside of guiding body 102. In an advantageous embodiment, the driving element 20 is an electric motor and cooperates with the vertically sliding member through a mechanism translating rotation of the electric motor to linear motion of the vertically sliding member, such as a ball screw or a roller screw mechanism. A connection means 103 for connecting with a stopper-rod arm is arranged in an upper portion of the guiding body 102. The connection means 103 is actuated by the vertically sliding member and undergoes vertical displacement in use.

Alternatively, the control device 10 does not comprise a vertically sliding member provided inside guiding body 102 and cooperating with the driving element 20. In that case, the driving element 20 cooperates with the rotating member 110 inside the guiding body 102. The rotating member 110 also cooperates with the connecting rod 101, both elements forming a rotation translation mechanism for transforming a rotation of the rotating member 110 into a vertical displacement of the connecting rod 101. The connecting rod 101 is connected to connection means 103 such to cause a vertical displacement of said connection means 103 under the action of the driving element 20.

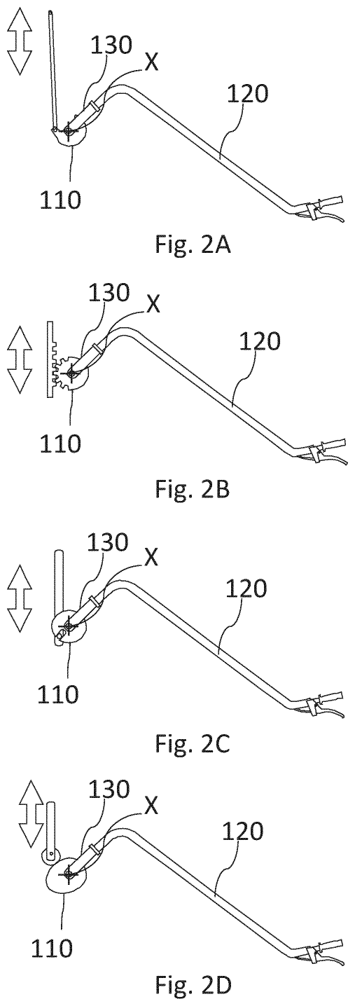

In the FIG. 1 embodiment, the stopper arm can also be actuated via the hand lever 120 in a manual control mode of the stopper-rod. For this purpose, the connecting rod 101 is provided with one end connected to the connection means 103 and the other to the rotating member 110, both elements forming a rotation translation mechanism for transforming a rotation of the hand lever 120 into a vertical displacement of the connection means 103. The rotation translation mechanism shown in FIG. 1 is a crank mechanism. Alternatively, other rotation translation mechanism can be foreseen such as a gear rack mechanism, a lever mechanism or a cam follower mechanism (as shown in FIG. 2B, 2C and 2D, respectively) besides the crank mechanism shown FIG. 2A corresponding to the advantageous embodiment according to FIG. 1.

In FIG. 1, the hand lever 120 comprises a handle section 126 holdable by an operator. By moving the hand lever 120 upward or downward, the operator can control the vertical position of the stopper-rod.

Preferably, the hand lever 120 comprises two main sections: a proximal section 121 adjacent to the rotating member 110 and a distal section 123. The distal section includes the handle section 126. The sections 121, 123 are detachably attached to one another.

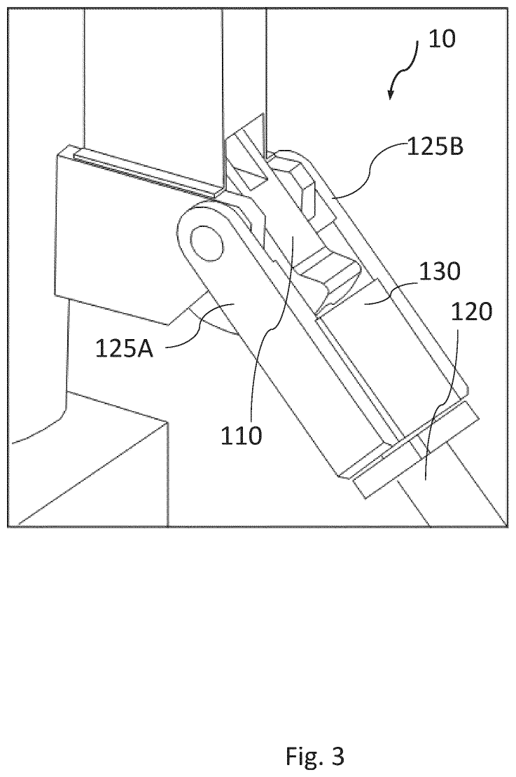

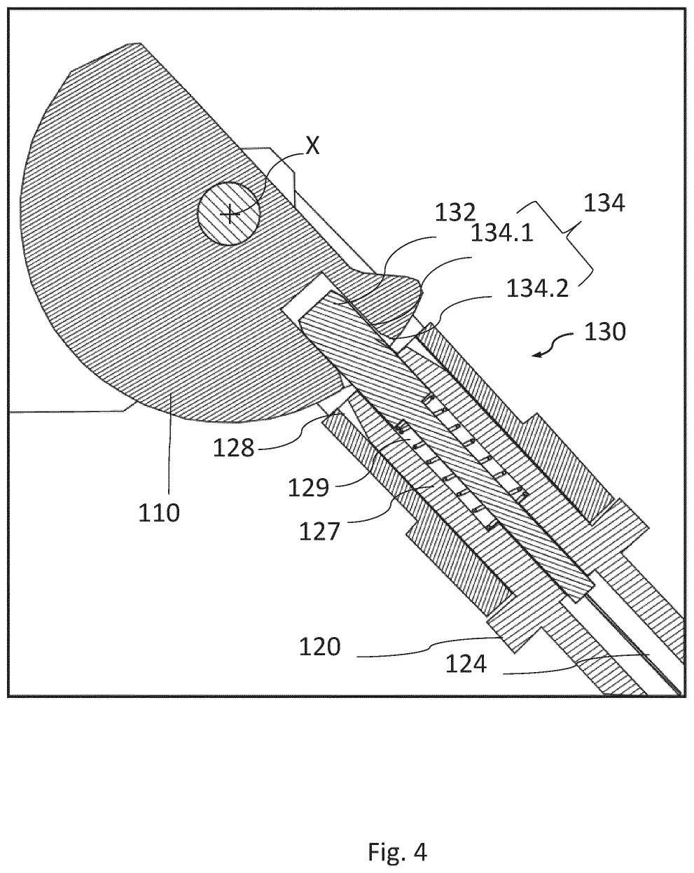

Advantageously, the hand lever 120 comprises an actuating member 122, preferably in the form of a lever, for controlling a coupling mechanism shown in FIGS. 3 and 4.

FIG. 3 illustrates a perspective view of a coupling mechanism 130. The coupling mechanism 130 allows to selectively connect the rotating member 110 to the hand lever 120 or to disconnect the rotating member 110 from the hand lever 120. In at least one embodiment, the rotating member 110 includes two arms that are connected to the connecting rod 101 via pin (not shown).

FIG. 4 shows a sectional view of a coupling mechanism 130. The coupling mechanism 130 comprises the rotating member 110 in the form of a crank member with an axis of rotation X. In a preferred embodiment, the coupling mechanism 130 is in the form of a no-slip clutch with a plunger radially movable relative to an inner member, namely the rotating member 110. The rotating member 110 and the hand lever 120 are pivotable about the same axis rotation X. In one embodiment, the rotating member 110 and the hand lever 120 are mounted about a common shaft. In FIG. 4, the clutch mechanism is advantageously integrated with a proximal end portion of the hand lever 120, in particular between the two proximal arms connected to the common shaft. The two proximal arms 125A, 125B extend, on both sides of the rotating member 110, from the proximal end portion to the common shaft. In one embodiment, a no-slip clutch with opposed teeth rows is arranged between a side of the rotating member 110 and one of said arms 125A, 125B. Alternatively, a friction clutch mechanism (e.g., disc, shoe) can be used too.

In FIG. 4, the coupling mechanism 130 comprises a plunger 132 that is integrated with the proximal section 121 of the hand lever 120. The plunger 132 moves radially relative to the rotating member 110. The rotating member 110 presents a recess 134 in which the plunger 132 can be received.

Advantageously, the recess 134 formed in the rotating member 110 comprises a guiding portion 134.2 with preferably a funnel shape surface to guide the sliding member, for e.g., in the form of plunger 132, during a transition from the disengaged state to the engaged state. During such a transition phase, the rotating member oscillates and the alignment of the protrusion 127 with the recess 128 before the engagement thereof is delicate. Thanks to the provision of the guiding portion 134.2, the protrusion 127 would still engage the recess 134, even when there is a slight offset in the alignment.

The recess 134 further comprises a cylindrical portion, and additionally or alternately a prismatic portion, in the form of lock portion 134.1. The lock portion 134.1 ensures a locking between the plunger 132 and the rotating member 110 in an engaged state. The coupling mechanism 130, in the engaged state, can be structured so that the maximal offset angle between the rotating member 110 and the hand lever 120 amounts to 2°, preferably 1°. The maximal offset angle is defined according to the needs of a given application. This measure limits the transmission of oscillation of the rotating member 110 during the automatic control while the coupling mechanism 130 is in an engaged state. Alternatively, the coupling mechanism 130, in the engaged state, can be structured so that that rotating member 110 rotates rigidly (free play) with the hand lever 120, thereby offering a better control during the manual mode.

The above mentioned oscillation transmission typically occurs during a transient mode (e.g. automatic control of the stopper-rod and rotating member 120 with the coupling mechanism 130 engaged) taking place during the transition from the automatic mode (i.e. automatic control of the stopper-rod and rotating member 110 with the coupling mechanism 130 disengaged) to the manual mode (i.e. manual control of the stopper-rod and rotating member 110 with the coupling mechanism 130 engaged). Conversely, a transient mode (e.g. automatic control of the stopper-rod with the coupling mechanism 130 engaged) can take place during the transition from the manual mode (i.e. manual control of the stopper-rod and rotating member 110 with the coupling mechanism 130 engaged) to the automatic mode (i.e. automatic control of the stopper-rod and rotating member 110 with the coupling mechanism 130 disengaged). In an alternative form, a transient mode can consist in holding in the rotating member 110 in a predefined position before the coupling mechanism is engaged or disengaged.

The rotating member 110 rotationally reciprocates while being driven by the driving element 20 in the automatic control of the stopper-rod. The driving element 20 is thus advantageously controlled in such a manner that the amplitude of the rotation of the rotating member 110 allows that the coupling mechanism 130 remains in the engaged state in the transient mode without the hand lever 120 colliding with other parts of said control device 10.

In FIG. 4, the distal section 123 and the proximal section 131 of the hand lever 120 are attached to one another by usual attachment means, such as, for e.g., quick connections (not shown). The distal section 123 of the hand lever 120 comprises an end portion ending with a protrusion 127. The proximal section 121 comprises an opposed end face, in which a recess 128 is formed. The dimension and form of both the protrusion 127 and the recess 128 are adapted so that the protrusion 127 is engaged in a form-fit manner within the recess 128.

As shown in FIG. 4, the displacement of the plunger 132 can be actuated via a cable 124 (for e.g., of a Bowden cable means), said cable 124 being connected to the actuating member 122 about the handle section 126 of the hand lever 120. The plunger 132 can reciprocate between a retracted and deployed position. In one embodiment, the plunger 132 is resiliently biased by a spring in the deployed position, corresponding to the engaged state, which is a default position in the embodiment according to FIG. 4. When the actuating member 122 is actuated by an operator, the plunger 132 is retracted and this causes the sliding member 132 to disengage from the rotating member recess 128, thereby disconnecting the coupling mechanism 130. The actuating member 122 can comprise a lock mechanism so that the plunger 132 is held in the retracted position within a chamber 129 formed in the protrusion 127 without requiring that the operator to continually keep pressing the actuating member 122. This lock mechanism is particularly useful for the automatic control when the hand lever 120 is disengaged from the rotating member and rests on the floor unattended.

The actuation means of the coupling mechanism 130 shown in FIG. 4 is particularly advantageous because it is simple, compact and reliable. Nevertheless other actuation means are also contemplated by the inventors, including, for e.g., a servo driven mechanism, and similar other mechanisms that are capable of achieving the same/similar effect.

The embodiments are described with an electric driving element 20. Alternatively, a pneumatic or hydraulic driving element 20 can be foreseen.

Although the present invention has been described and illustrated in detail, it is clearly understood that the same is by way of illustration and example only and is not to be taken by way of limitation, the scope of the present invention being limited only by the terms of the appended claims.

1. A control device (10) for a metallurgical vessel stopper-rod, said device (10) being operable to switch between a manual mode and an automatic mode, said device (10) being connectable to an electric, pneumatic or hydraulic driving element (20), said stopper-rod being manually actuated by an operator in the manual mode for a manual control of a molten metal flow, while in the automatic mode, said stopper-rod is actuated by said driving element (20) for an automatic control of the molten metal flow, said device further comprising:
a rotating member (110), in particular in a cam-, gear-, arm- or crank-member form, movable in rotation about an axis (X) of rotation, wherein the control device (10) is structured so that the rotating member (110) mechanically cooperates with said stopper-rod in such manner that a vertical displacement of said stopper-rod is a function of a rotation of the rotating member (110) causing the rotating member (110) to cooperate mechanically with the driving element (20) in use;
a hand lever (120) movable in rotation about the axis (X) of rotation and holdable by an operator to manually control the vertical displacement of said stopper-rod in the manual mode;
a coupling mechanism (130) connecting the rotating member (110) and the hand lever (120), said coupling mechanism (130) being structured so that in a disengaged state, the rotating member (110) and the hand lever (120) are both rotatable about the axis (X) independently from one another thereby preventing the transfer of mechanical power from the driving element (20) to the hand lever (120) in the automatic mode, while in an engaged state, the hand lever (120) and the rotating member (110) rotate together about the axis (X) of rotation thereby allowing said stopper-rod being manually actuated by an operator in the manual mode.

2. The control device according to claim 1, wherein the hand lever (120) comprises a proximal section (121) adjacent to the rotating member (110) and a distal section (123) including a handle section (126), said distal section (123) being detachable from said proximal section (121).

3. The control device according to claim 1, wherein the coupling mechanism (130) comprises a sliding member (132), mounted in translation relative to the hand lever (120) and a recess (134) formed in the rotating member (110), said coupling mechanism (130) being structured so that the sliding member (132) is engaged with the recess (134) when the coupling mechanism is in the engaged state.

4. The control device according to claim 3, wherein the recess (134) comprises a guiding portion (134.2) with a funnel shape surface so as to guide the sliding member (132) during a transition from the disengaged state to the engaged state.

5. The control device according to claim 3, wherein the recess (134) comprises a cylindrical or prismatic lock portion (134.1) ensuring a locking between the sliding member (132) and the rotating member (110) in the engaged state.

6. The control device according to claim 1, wherein the hand lever (120) comprises an actuating member (122), for selecting either the engaged or disengaged state.

7. The control device according to claim 6, wherein the actuating member (122) mechanically cooperates with the sliding member (132) via a Bowden cable means,
wherein the coupling mechanism (130) comprises a sliding member (132), mounted in translation relative to the hand lever (120) and a recess (134) formed in the rotating member (110), said coupling mechanism (130) being structured so that the sliding member (132) is engaged with the recess (134) when the coupling mechanism is in the engaged state.

8. The control device according to claim 3, wherein the distal section (123) of the hand lever (120) comprises an end portion presenting a protrusion (127) and the proximal section (121) comprises an end face with a recess (128) formed thereon, said protrusion (127) being adapted to be engaged in a form-fit manner in said recess (128) when the distal section (123) is attached to the proximal section (121),
wherein the hand lever (120) comprises a proximal section (121) adjacent to the rotating member (110) and a distal section (123) including a handle section (126), said distal section (123) being detachable from said proximal section (121).

9. The control device according to claim 8, wherein the sliding member (132) is received within a chamber (129) formed in the protrusion (127) of the distal member (123),
wherein the coupling mechanism (130) comprises a sliding member (132), mounted in translation relative to the hand lever (120) and a recess (134) formed in the rotating member (110), said coupling mechanism (130) being structured so that the sliding member (132) is engaged with the recess (134) when the coupling mechanism is in the engaged state.

10. The control device according to claim 9, wherein the sliding member (132) is biased by a resilient means in a deployed configuration, in which the sliding member (132) is engaged with the recess (134) in use, and connected to the actuating member (122), in particular the lever, via a cable (124) of the Bowden cable means, said cable (124) extending from a sliding member (132) end portion to an arm of the actuating member (122), wherein optionally the actuating member (122) is in lever form,
wherein the actuating member (122) mechanically cooperates with the sliding member (132) via a Bowden cable means,
wherein the coupling mechanism (130) comprises a sliding member (132), mounted in translation relative to the hand lever (120) and a recess (134) formed in the rotating member (110), said coupling mechanism (130) being structured so that the sliding member (132) is engaged with the recess (134) when the coupling mechanism is in the engaged state.

11. The control device according to claim 1, wherein the control device (10) is structured to be operable in a transient mode during a transition from the manual control to the automatic control or vice versa, in which the stopper-rod is actuated by said driving element (20) for an automatic control of the molten metal flow while the coupling mechanism (130) is in the engaged state, causing the hand lever (120) to be actuated by the driving element (20) and to rotate together with the rotating member (110).

12. The control device according to claim 1, wherein when the coupling mechanism (130) is in the engaged state, the coupling mechanism (130) is structured so that:
the maximal of offset angle between the rotating member (110) and the hand lever (120) amounts to 2°, and/or
the rotating member (110) rotates rigidly with the hand lever (120).

13. A kit for mounting a stopper-rod assembly, wherein said kit comprises a stopper-rod, a control device for a metallurgical vessel stopper-rod and an electric, pneumatic or hydraulic driving element (20) for being connected to said control device, said assembly being adapted to be arranged in or at a bottom of a metallurgical vessel, in particular a tundish or ladle, wherein said control device for a metallurgical vessel stopper-rod is a control device (10) according to claim 1.

14. A metallurgical vessel wherein is mounted a kit for mounting a stopper-rod assembly according to claim 13.

15. (canceled)

16. The control device according to claim 3, wherein the sliding member (132), is in a plunger form.

17. The control device according to claim 4, wherein the recess (134) comprises a cylindrical or prismatic lock portion (134.1) ensuring a locking between the sliding member (132) and the rotating member (110) in the engaged state.

18. The control device according to claim 6, wherein the actuating member (122) is a hand actuating member.

19. The control device according to claim 6, wherein the actuating member (122) is a lever.
